(19) United States
(12) Patent Application Publication
(10) Pub. No.: US 2007/0127059 A1
(43) Pub. Date: Jun. 7, 2007

(54) Image processing apparatus, charge management device connection device, charge management program product and charge management method

(75) Inventors: Takuya Honda, Kanagawa (JP); Takashi Hirata, Kanagawa (JP); Masahiro Iwata, Kanagawa (JP); Daigo Yamagishi, Kanagawa (JP); Shinji Akahira, Kanagawa (JP)

Correspondence Address: OLIFF & BERRIDGE, PLC, P.O. BOX 19928, ALEXANDRIA, VA, 22320, US

(73) Assignee: Fuji Xerox Co., Ltd., Tokyo (JP)

(21) Appl. No.: 11/402,873

(22) Filed: Apr. 13, 2006

(30) Foreign Application Priority Data
Dec. 6, 2005 (JP) 2005-351477

(51) Int. Cl. G06F 3/12; G06F 15/00

(52) U.S. Cl. 358/1.15; 358/448

(57) ABSTRACT

An image processing apparatus that includes: a job processor that processes a job for image data; a job management unit that manages execution of the processing of the job; a connector to which a plurality of charge management devices that charge for the processing of the job are connected; a charge management selector that selects one of the plurality of charge management devices to charge for the processing of the job, the selection is based on operating states of the plurality of the charge management devices and is maintained until the processing of the job is performed; and a storage unit that stores a result of the selection made by the charge management selector when the processing of the job is started.

### BACKGROUND

1. Technical Field

The present invention relates to an image processing apparatus that can not only process a job for image data, but can also charge for processing the job, a charge management device attached connection device, a charge management program product and a charge management method.

2. Related Art

Apparatuses such as copiers installed in offices and convenience stores, for which charges are assessed for the processing of jobs, are widely employed as image processing apparatuses for performing the copying and printing of documents. Specifically, an apparatus for which the processing of a job is contingent on the insertion of a card into a card reader (or on the near proximity of a non-contact card) and an apparatus for which the processing of a job is contingent on the insertion of coins into a coin operated vending mechanism are known. Another type of recently introduced image processing apparatus permits the use of a card reader that can appropriately charge for use by persons whose identity is known, as well as the use of a coin operated vending mechanism that is appropriate for charging for services rendered anonymous persons. Such an apparatus can therefore cope with employment in a mixed use environment shared by specific, identified people and anonymous people. For example, this apparatus is applicable to a public facility used by both staff members and the general public

### SUMMARY

Therefore, one objective of the present invention is to provide an image processing apparatus wherein, when a plurality of charge management devices for enabling charging are available, erroneous, unexpected charges can be prevented, even when the state of a charge management device is shifted during the processing of a job or when the processing of a job is halted, interrupted, and thereafter resumed. The present invention also provides a charge management device attached connection device, a charge management program product and a charge management method.

An image processing apparatus according to an aspect o the invention includes: a job processor that processes a job for image data; a job management unit that manages execution of the processing of the job; a connector to which a plurality of charge management devices that charge for the processing of the job are connected; a charge management selector that selects one of the plurality of charge management devices to charge for the processing of the job, the selection is based on operating states of the plurality of the charge management devices and is maintained until the processing of the job is performed; and a storage unit that stores a result of the selection made by the charge management selector when the processing of the job is started.

### BRIEF DESCRIPTION OF THE DRAWINGS

Embodiments of the present invention will be described in detail based on the following figures, wherein:

FIG. 1 is a schematic functional block diagram showing an example configuration of an image processing system that includes an image processing apparatus according to an embodiment of the present invention;

FIG. 2 is a schematic functional block diagram showing an example configuration of an image processing system that includes a charge management device attached connection device according to another embodiment of the present invention;

FIG. 3 is a flowchart showing example processing performed when the image processing system in FIG. 1 or 2 is activated;

FIG. 4 is a timing chart showing an overview of a selection performed when the image processing system in FIG. 1 or 2 starts a processing job;

FIG. 5 is a flowchart showing example processing performed when the image processing system in FIG. 1 or 2 starts a processing job;

FIG. 6 is a flowchart showing example processing performed after the image processing system in FIG. 1 or 2 has started a processing job; and

FIG. 7 is a flowchart showing another processing example performed after the image processing system in FIG. 1 or 2 has started a processing job.

### DETAILED DESCRIPTION

An image processing apparatus, a charge management device attached connection device, a charge management program and a charge management method according to an aspect of the present invention will now be described, while referring to the drawings.

[Explanation for Example system configuration]

The system configuration for which the present invention is applied will now be described.

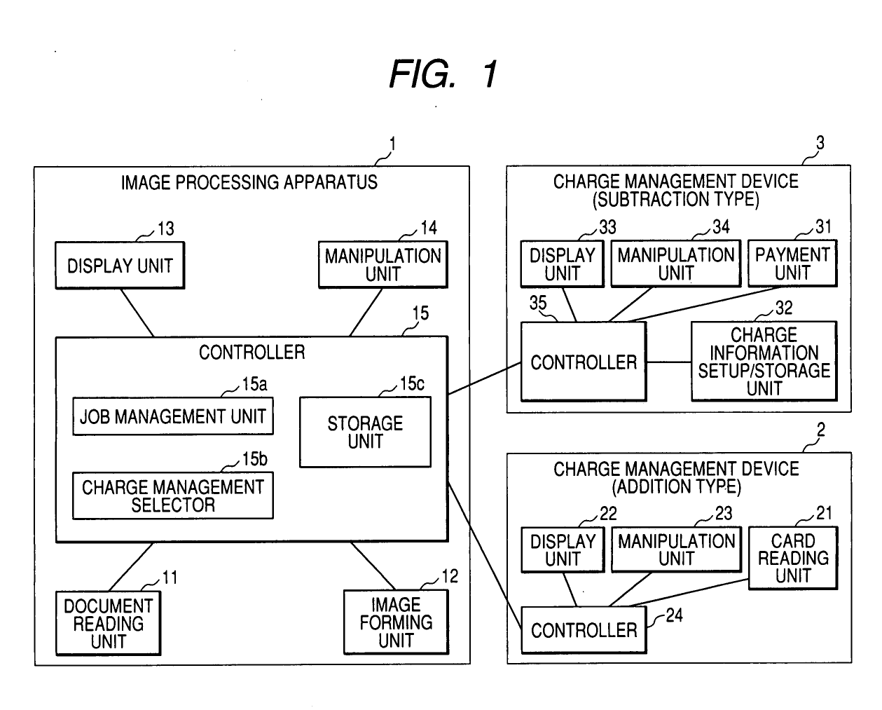

FIG. 1 is a schematic functional block diagram showing an example configuration for an image processing system that includes an image processing apparatus according to the present invention. As shown in FIG. 1, the image processing system used for this explanation comprises: an image processing apparatus 1 and a plurality of mutually connected charge management devices 2 and 3.

The image processing apparatus 1 is, for example, a digital copier or a multi-functional machine that includes a copying function, a printing function and a facsimile function, and not only performs a processing job for image data, such as document copying or printing, but also manages the execution of the processing job. For this purpose, the image processing apparatus 1 includes a document reading unit 11, for obtaining image data by reading images on an original document, and an image forming unit 12, for using the obtained image data to print images based on the obtained image data. These units serve as a job processor for processing an image data job. The image processing apparatus 1 also includes a display unit 13, for displaying, for a user of the image processing apparatus 1, information related to the processing of a job, and a manipulation unit 14, which permits the user to enter information. The image processing apparatus 1 further includes a controller 15, for managing a processing job performed by the document reading unit 11 or the image forming unit 12, and for charging for the processing job. The job management process and the charging process performed by the controller 15 will be described later in detail.

The charge management devices 2 and 3 charge a user for the processing job performed by the image processing apparatus 1. It should be noted that both types of devices could be present as these charge management devices 2 and 3, i.e., a charge management device of an addition type that adds charges to obtain a total consonant with the volume of a processing job performed for a specified user who is to be charged, and a charge management device of a subtraction type that subtracts, from a predetermined value, a charge consonant with the volume of a processing job. Note, however, that the device types that can be used are not limited to the ones described here.

The addition type charge management device 2 is, for example, an IC card reader, and includes: a card reading unit 21, for reading information from an IC card that specifies a user (a job requester); a display unit 22, for displaying various information for the user; a manipulation unit 23, which permits the user to enter information; and a controller 24, for controlling the operation of the entire charge management device 2. The controller 24 has a function for determining whether the charge management device 2 is active (in a charging enabled state) or inactive (in a charging disabled state), and for transmitting the obtained results to the controller 15 of the image processing apparatus 1. For a determination of the active state/inactive state, whether or not an IC card has been inserted into the card reading unit 21 maybe examined when the IC card is a slot insertion type. For an IC card of a non-contact type, the active state is determined when the IC card is brought near the card reading unit 21 and held there for the reading of information to be enabled, and the inactive state is determined when an approval cancel button on the manipulation unit 23 is depressed.

The subtraction type charge management device 3 is, for example, a coin operated vending mechanism, or a prepaid card reader, and includes: a payment unit 31, for the insertion of coins and the payment of a charge (or the return of change, as appropriate), or a payment made in accordance with information read from a prepaid card; a charge information setup/storage unit 32, for managing the amount of a payment for the payment unit 31; a display unit 33, for displaying a variety of information for a user; a manipulation unit 34, which permits the user to enter information; and a controller 35, for controlling the entire operation of the charge management device 3. The controller 35 has a function for determining whether the charge management device 3 is active (in a charging enabled state) or inactive (in a charging disabled state), and for transmitting the results to the controller 15 of the image processing apparatus 1. For a decision as to whether the state is active or inactive, whether there is a payment to be made to the payment unit 31, and whether there is a balance remaining must be determined through an examination.

The charge management devices 2 and 3 are connected to the image processing apparatus 1, via the connection port (not shown) of the image processing apparatus 1, to perform bidirectional communication.

Another example system configuration for which the present invention can be applied will now be explained.

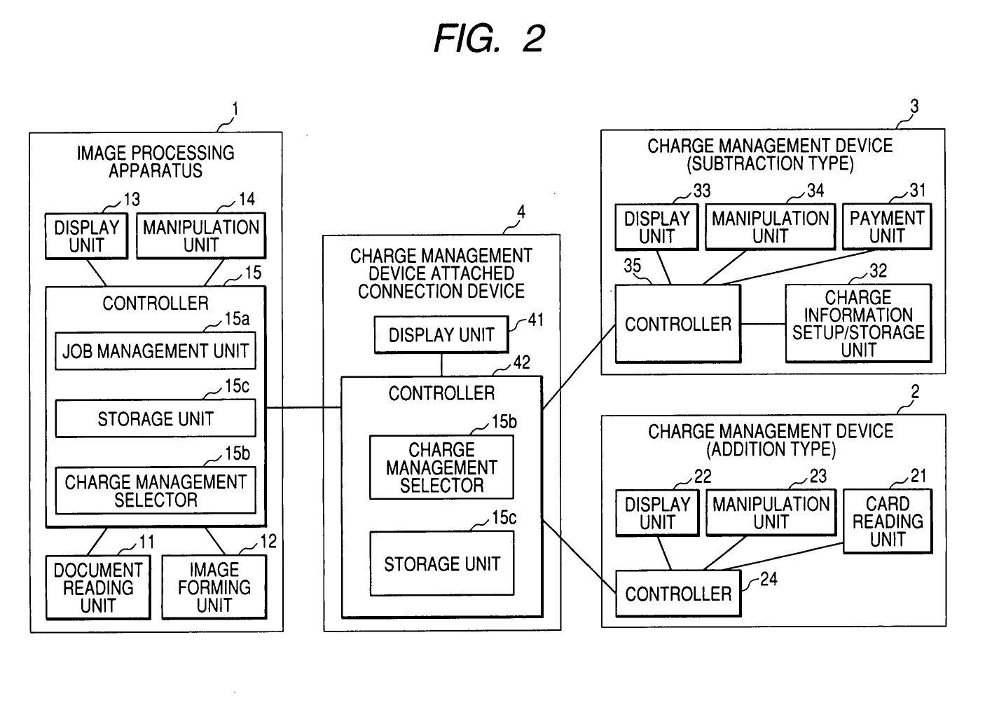

FIG. 2 is a schematic functional block diagram showing an example configuration for an image processing system that includes a charge management device attachment connection device according to the present invention. As shown in FIG. 2, the image processing system in this explanation comprises: an image processing apparatus 1, a plurality of charge management devices 2 and 3, and a charge management attached connection device 4 located in between.

The image processing apparatus 1 and the charge management devices 2 and 3 are substantially the same as those for the above described image processing system. When the image processing apparatus 1 includes a connection port for the charge management devices 2 and 3, specifically, a plurality of connection ports, the configuration of the above described image processing system can be provided. However, the image processing apparatus 1 does not always have a plurality of connection ports. That is, in order to establish a connection between the charge management devices 2 and 3 and an image processing apparatus 1 having only one connection port, the charge management device, attached connection device 4 is located in between.

The charge management device, attached connection device 4 is an adaptor that connects one image processing apparatus 1 to a plurality of charge management devices 2 and 3, and includes: a display unit 41, for displaying information for a user, as needed; and a controller 42, for controlling an operation performed to establish a connection between the image processing apparatus 1 and the charge management devices 2 and 3. The operation performed by the controller 42 will be described in detail later.

[Explanation of Example Functional Configurations]

The characteristic functional configurations of the individual image processing systems described above will now be explained.

As shown in FIGS. 1 and 2, the controller 15 of the image processing apparatus 1 includes the function of a job management unit 15a that manages a processing job, more specifically, it manages the order in which jobs are performed, and the starting, halting, resumption and ending of processes. Through the operation of the job management unit 15a, the image processing apparatus 1 can sequentially initiate multiple processing jobs in a processing queue, can perform an interruption process for the performance of a job having a higher priority, can halt or resume a processing job currently being performed for which there is an accompanying the interrupt process, or can halt, and resume, processing currently being performed due to the occurrence of an error (e.g., the out of paper).

Further, the image processing apparatus 1, or, at the least, either the image processing apparatus 1 or the charge management device, attached connection device 4, if it is provided, has the functions of a charge management selector 15b and a storage unit 15c. Since these functions must be provided for, “at the least, either one of the two devices”, the functions maybe provided separately for the image processing apparatus 1 and the charge management device, attached connection device 4, or maybe provided for both the image processing apparatus 1 and the charge management device, attached connection device 4.

The charge management selector 15b serves as a charge management selector for selecting one of the charge management devices 2 and 3 for charging for a processing job performed by the image processing apparatus 1. The selection of the charge management devices 2 and 3, performed by the charge management selector 15b, will be described in detail later.

The storage unit 15c serves as a storage unit wherein the results of a selection made by the charge management selector 15b are stored when the image processing apparatus 1 starts a processing job, i.e., information indicating which of the charge management devices 2 and 3 was selected by the charge management selector 15b, is stored, at the least, until the processing job is ended. The storage form, such as the format used for information, is not especially limited, and any form that employs a well known technique is available for use.

The individual sections 15a to 15c can be provided when the function of the computer in the image processing apparatus 1 or the attached charge management device, connection device 4 executes a predetermined program. That is, the predetermined program is installed in advance in the image processing apparatus 1 or in the charge management device, attached connection device 4. In this case, the predetermined program may be installed by being stored on a computer-readable recording medium, or by being distributed via wired or wireless communication unit. That is, the image processing apparatus 1 or the charge management device, attached connection device 4 having the above described configuration can be provided by using an image processing program that permits a computer to serve as the image processing apparatus 1 or the charge management device, attached connection device 4.

[Explanation of an Example Operation]

An example operation of the thus arranged image processing systems, i.e., a charge management method according to the present invention, will now be described.

First, the processing performed when the system is activated will be explained.

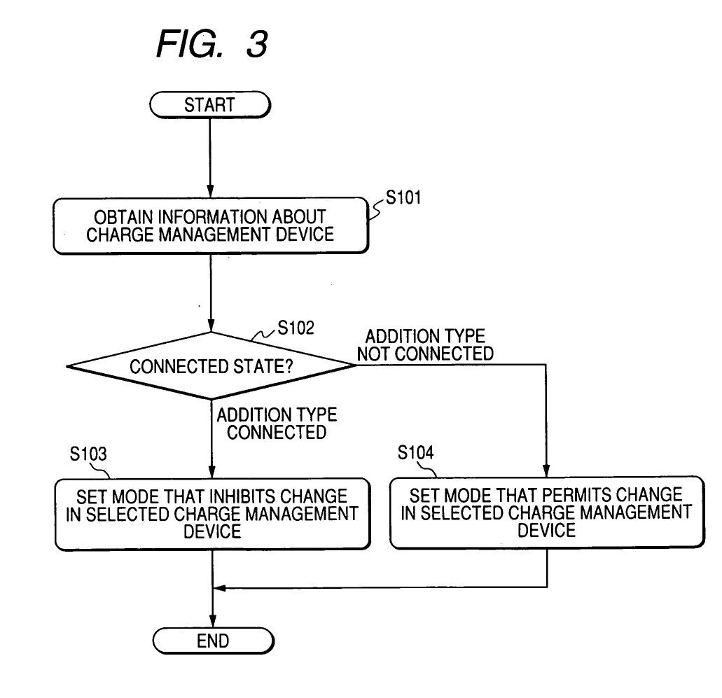

FIG. 3 is a flowchart showing example processing performed when the system is activated.

When the system is activated, the function of the charge management selector 15b of either the image processing apparatus 1 or the charge management device, attached connection device 4, transmits an inquiry to the individual charge management devices 2 and 3 connected to the image processing apparatus 1 or the charge management device, attached connection device 4, and obtains information about the types of the charge management devices 2 and 3 (steps 101; hereinafter a step is referred to simply as “S”). Thus, the charge management selector 15b can determine whether the individual charge management devices 2 and 3 are an IC card reader, a coin operated vending mechanism, or a prepaid card reader, i.e., an addition type or a subtraction type. The exchange of information at this time can be performed by employing an arbitrary well known technique.

Based on the information obtained for the types of charge management devices 2 and 3, the charge management selector 15b determines whether an addition type device, such as an IC card reader, is present among the charge management devices 2 and 3 that are connected (S102). That is, the charge management selector 15b determines whether the charge management device 2, which uses addition to perform charging, and the charge management device 3, which uses subtraction to perform charging, are connected together.

When an addition type device is included, and when both an addition type and a subtraction type are present, the charge management selector 15b designates a mode for selecting the charge management devices 2 and 3 to a mode in which a change in the selection during the processing is inhibited (S103). For example, when the charge management devices 2 and 3 are, respectively, an IC card reader and a coin operated vending mechanism, the charge management selector 15b designates the mode that inhibits a change in the selection during the processing.

When an addition type device is not included, and when only the subtraction type is present, the charge management selector 15b designates the mode for the selection of the charge management devices 2 and 3 to a mode that permits a change in the selection during the processing (S104). For example, when the charge management devices 2 and 3 are a coin operated vending mechanism and a prepaid card reader, the charge management selector 15b designates the mode that permits a change in the selection during the processing.

The operation related to the selection of the charge management devices 2 and 3 will now be explained.

First, selection of the charge management device 2 or 3 when a processing job is started will now be described.

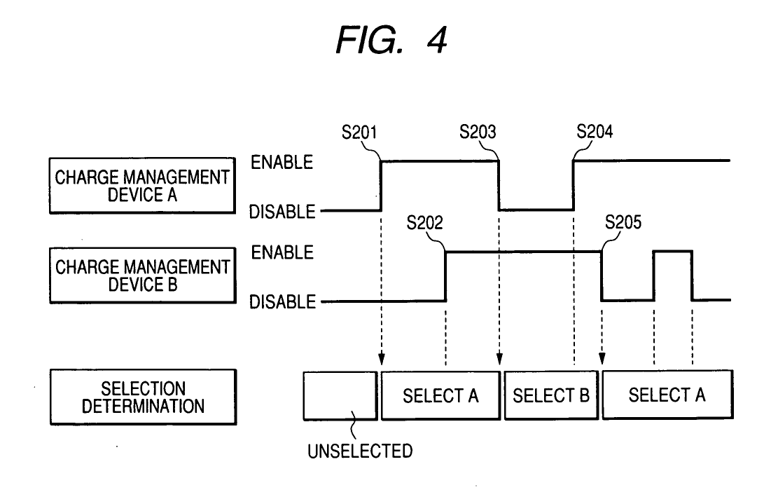

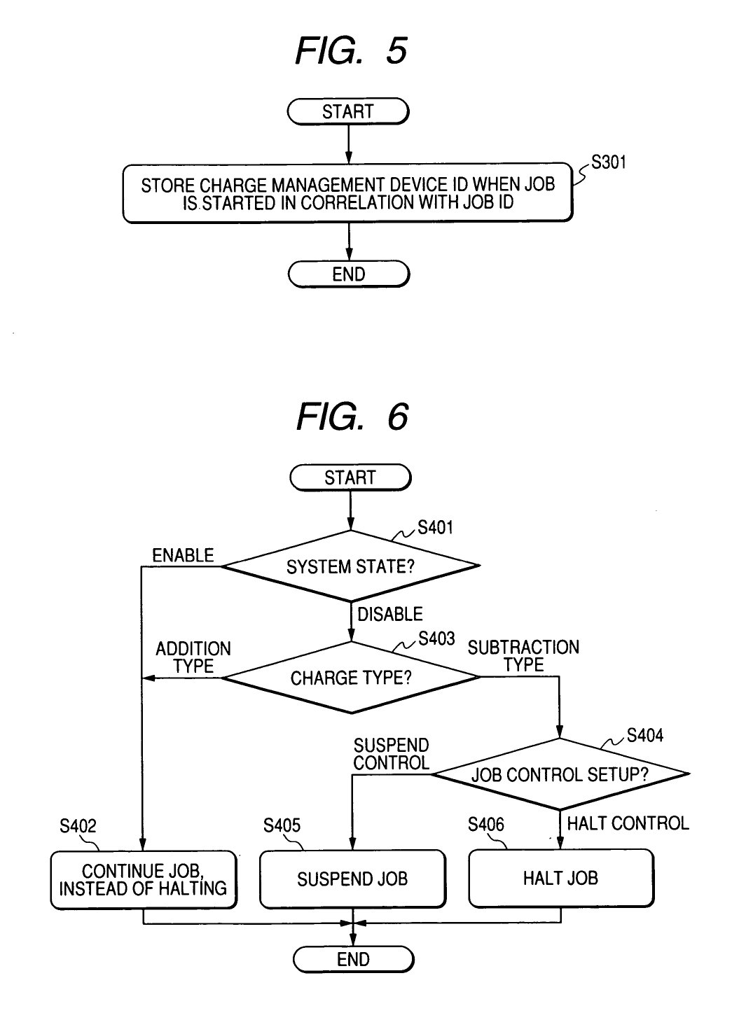

FIG. 4 is a timing chart showing an overview of the selection when a processing job is started, and FIG. 5 is a flowchart showing an example of the processing performed at the start of a processing job.

Since a plurality of charge management devices 2 and 3 are connected, when a processing job is to be started, the charge management selector 15b must select which of the charge management devices 2 and 3 to use for charging for the processing job to be executed. This selection is made in accordance with the operating states of the charge management devices 2 and 3. That is, based on a notification received from the controllers 24 and 35 of the charge management devices 2 and 3, the charge management selector 15b determines whether the charge management devices 2 and 3 are active or inactive, and selects the charge management device 2 or 3 that is in the operating state. At this time, a plurality of devices may be active, and in this case, the time sequence according to which the devices are shifted from the inactive state to the active state is determined, and a device that is to be shifted to active is selected first.

Assume that, as shown in FIG. 4, a charge management device A is changed from the inactive state (Disabled) to the active state (Enabled) (S201), and a charge management device B is changed from the inactive state (Disabled) to the active state (Enabled) (S202), thereafter, while the charge management device B is maintained active, the charge management device A is shifted from active to inactive (S203) and from inactive to active (S204), and further, while the charge management device A is maintained active, the charge management device B is shifted from active to inactive (S205). In this case, before S201, the charge management selector 15b selects neither of the charge management devices A and B because they are inactive. However, between S201 and S203 the charge management device A is selected because, at S202, the charge management device A becomes active first, even when the charge management device B is shifted from inactive to active. Thereafter, when the charge management device A becomes inactive at S203, the charge management selector 15b selects the charge management device B because this device is active. Up to S205, the charge management device B is active first, even when at S204 the charge management device A is shifted from inactive to active, so that the charge management selector 15b selects the charge management device B.

Since the device that is shifted first is preferentially selected, the charge management selector 15b may transmit to the charge management device 2 or 3 that is shifted later a notification that the pertinent device is not selected, and may force the pertinent device to be shifted to the inactive state. That is, instead of the active state being maintained for the charge management device 2 or 3 that is shifted later, from inactive to active, an approval error may be displayed when the pertinent device, for example, is an IC card reader, or coins maybe returned to forcibly shift to the inactive state when the pertinent device is a coin operated vending mechanism.

In this manner, to start a processing job, the charge management selector 15b selects one of the charge management devices 2 and 3 to charge for the processing job. And when a selection is made by the charge management selector 15b, the job management unit 15a starts the processing job.

When the processing job is started, as shown in FIG. 5, the storage unit 15c stores the results of the selection by the charge management selector 15b at the start of the processing job, i.e., information as to which of the charge management devices 2 and 3 was selected by the charge management selector 15b (S301). Specifically, the storage unit 15c employs ID information (hereinafter referred to as “device IDs”) that are uniquely provided, in advance, for the charge management devices 2 and 3 to store information relative to the selection results obtained from the charge management selector 15b. This information should be stored at least until the processing job is ended. The ending of the processing job includes not only completion of the job, but also the canceling of a job (the ending of a job when instructed by a user).

Furthermore, it is preferable that, even after the processing job is ended, information be held in the storage unit 15c, or that, while taking into account the occurrence of a job interruption process, the selection results obtained by the charge management selector 15b be stored in correlation with information for a corresponding processing job. Specifically, the device ID is stored in correlation with ID information (hereinafter referred to as a “job ID”) that is provided for an individual processing job in order to identify the job.

The process for selecting the charge management devices 2 and 3 after the processing job has been started will now be described.

FIG. 6 is a flowchart showing example processing performed after the processing job has been started.

After the processing job has been started, the charge management selector 15b continues to monitor the states of the charge management devices 2 and 3, and determines whether the charge management device 2 or 3 that has been selected to charge for the currently executed processing job is maintained active, or is shifted from active to inactive (S401).

When the charge management selector 15b determines that the selected charge management device 2 or 3 is being maintained active, the job management unit 15a, upon receiving the determination results, continues the current processing job instead of halting it (S402).

When the charge management selector 15b determines that the selected charge management device 2 or 3 has been shifted to inactive, the charge management selector 15b determines whether the charge management device 2 or 3 is an addition type or a subtraction type (S403). When the charge management selector 15b determines the charge management device 2 or 3 is an addition type, the job management unit 15a, upon receiving the determination results, continues the job instead of halting it (S402). As a result, when the charge management device 2 is shifted to inactive during the execution of the processing job, and when, for example, the subtraction type charge management device 3 becomes active at this time, the charging for the current processing job is still performed by the charge management device 2 that was designated based on information stored in the storage unit 15c. That is, when the addition type charge management device 2 was selected, based on the contents of the storage unit 15c, by the charge management selector 15b at the start of the processing job, this selection is maintained until the processing job is completed, even when the charge management device 2 is shifted from active to inactive during the execution of the processing job. This is done for the following reasons. For charging by using the addition type charge management device 2, once the charge management device 2 becomes active, the specifying of the user to charge and the charging of the user are enabled. Therefore, even when, during the processing job, the device is shifted to inactive by the removal of a card, to improve the usability for the user, the processing job should not be halted. Also, the loss of the advantage obtained by using the charging operation of the addition type charge management device 2 can be avoided.

When the subtraction type charge management device 3 has been shifted from active to inactive, the job management unit 15a receives the determination results for that action from the charge management selector 15b, and determines whether a job control setup is for control to be suspended or halted (S404). The job control setup is the setup concerned with the handling of a job when the subtraction type charge management device 3 is shifted from the active state to the inactive state. This job control setup is designated in advance in the job management unit 15a, or is designated in accordance with an instruction entered at the manipulation unit 14 of the image processing apparatus 1. The suspend control is a process performed during which the subtraction type charge management device 3 is shifted to the inactive state during the execution of a processing job, the current processing job is suspended (enters a processing wait state) until the charge management device 3 becomes active again, for example, by the insertion of more coins. The halt control is a process during which, when the subtraction type charge management device 3 is shifted to the inactive state during the execution of a processing job, the job currently being processed is halted at that time. Therefore, when the job control setup suspends control, the job management unit 15a maintains the current processing job in the suspended state (S405), and displays information, such as the shortage of a fee, on the display unit 33 of the charge management device 3. When the job control setup is for the halting of control, the job management unit 15a halts the job currently being processing (S406). That is, for the subtraction type charge management device 3, continuation of a processing job being performed for the addition type charge management device 2 is aborted (selection when the processing job to be started is not maintained, based on the contents of the storage unit 15c). This takes into account the characteristic of the subtraction type charge management device 3 for which the use mainly by anonymous people is assumed.

An explanation will now be given for the use of the charge management device 2 or 3 when a processing job is halted or interrupted after the processing was started.

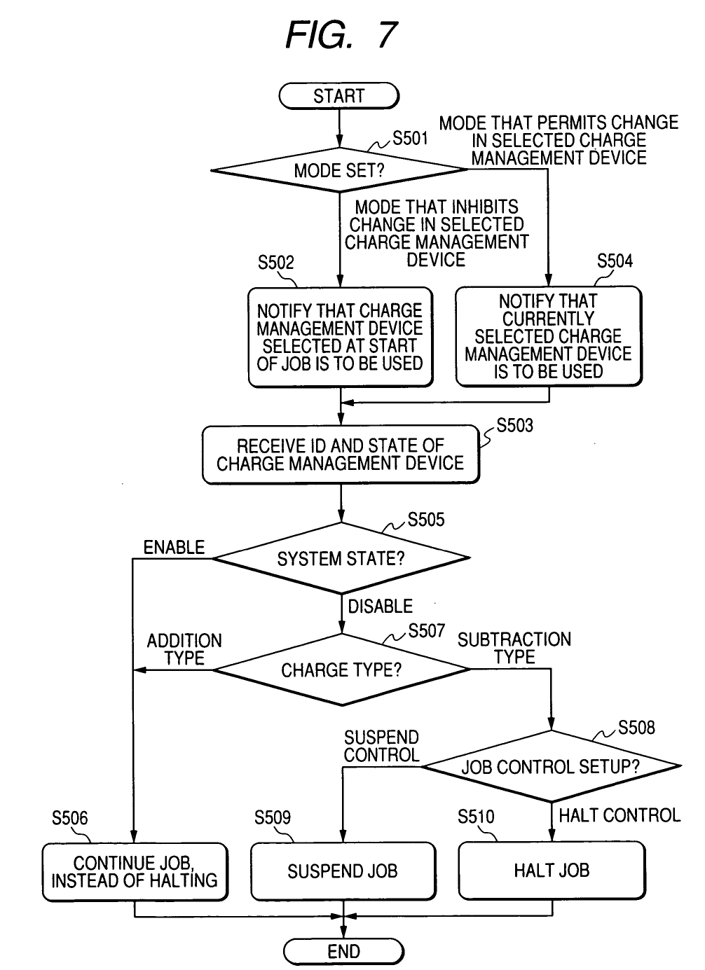

FIG. 7 is a flowchart showing other processing performed after a processing job is started.

During a processing job, when an error, such as the out of paper, has occurred in the document reading unit 11 or the image forming unit 12, the job management unit 15a temporarily halts the current job and resumes the processing after the error has been corrected. Further, during the execution of a processing job, when the performance of a processing job having a higher priority level is directed, the job management unit 15a temporarily halts the job currently being processed, performs the processing job having the higher priority level, and thereafter resumes the processing job that was temporarily halted.

When the processing of a job is halted temporarily and is to be resumed later, as shown in FIG. 7 the job management unit 15a determines whether a mode designated at the job resumption time is a mode that inhibits a change in the selection of the charge management devices 2 and 3, or a mode that permits such a change (S501). This determination can be performed based on the connection form of the charge management devices 2 and 3, or in accordance with an instruction entered at the manipulation unit 14 of the image processing apparatus 1. Specifically, when both an addition type and a subtraction type are present among the charge management devices 2 and 3, the job management control unit 15a determines that the job resumption mode is the mode that inhibits a change. When only the subtraction type is included, the job management control unit 15a determines that the job resumption mode is the mode that allows a selection change.

When the job resumption mode is the mode that inhibits the selection change, the job management unit 15a transmits a notification to the charge management selector 15b, indicating that the same charge management device 2 or 3 is selected as when the processing job was started (S502). Upon receiving this notification, the charge management selector 15b employs the contents of the selector 15c to select the same charge management device 2 or 3 as was selected when the processing job was started. Then, information (the device ID and the active/inactive state) for the selected charge management device 2 or 3 is transmitted to the job management unit 15a in order for the job management unit 15a to resume the processing job (S503).

That is, when, for example, both the addition type charge management device 2 and the subtraction type charge management device 3 are connected, for the resumption of a processing job, the charge management selector 15b employs the contents of the storage unit 15c to select the same charge management device 2 or 3 as was selected when the processing job was started.

When the job resumption mode is determined to be the mode that permits a selection change, the job management unit 15a transmits a notification to the charge management selector 15b indicating that upon the resumption of the processing job the currently selected charge management device 2 or 3 will still be employed, or that selection of the charge management device 2 or 3 will be entrusted to the charge management selector 15b (S504). Upon receiving this notification, the charge management selector 15b selects the charge management device 2 or 3 that is currently selected, or selects a charge management device 2 or 3 in accordance with the active/inactive state. Then, information for the selected charge management device 2 or 3 is transmitted to the job management unit 15a in order for the job management unit 15a to resume the processing job (S503). When the charge management device 2 or 3 selected at this time differs from the charge management device 2 or 3 that is currently selected and being used, the charge management selector 15b transmits an approval cancellation command to the currently selected charge management device 2 or 3 to shift to the inactive state.

That is, when, for example, only the subtraction type charge management device 3 is connected, the charge management selector 15b selects an appropriate charge management device each time for the resumption of a processing job. This is done for the following reason. When a coin operated vending mechanism and a prepaid card reader, for example, are connected as the subtraction type charge management devices 3, and when charging using a prepaid card before a processing job is halted is changed to charging requiring the insertion of coins when the job is resumed, no particular user inconvenience occurs, instead, usability is improved.

When the charge management selector 15b selects the charge management device 2 or 3 for the resumption of a processing job in this manner, the job management unit 15a employs the selected charge management device 2 or 3 to perform charging, and resumes the processing job that was temporarily halted.

After the processing job has been resumed, the processing is performed as in the above described processing job case (see FIG. 6) (S505 to S510).

As described above, according to the image processing apparatus 1, the charge management device, attached connection device 4, the charge management program and the charge management method explained in this embodiment, the selection results for the charge management devices 2 and 3 when a processing job is started are stored in the storage unit 15c. Thus, based on the contents of the storage unit 15c, this selection is maintained from the start to the end of the processing job. Therefore, during the processing job, when the selected charge management device 2 is shifted from the active state to the inactive state, the selection is maintained until the end of the current processing job, and the charging for the processing job can be performed by the selected charge management device 2. Further, when the processing job is temporarily halted and is thereafter resumed, the same charge management device 2 that was selected when the processing job was started can be selected at the time of the resumption.

That is, according to the image processing apparatus 1, the charge management device, attached connection device 4, the charge management program and the charge management method of the embodiment, and based on the contents of the storage unit 15c, the selection made of the charge management device 2 or 3 when a processing job is started can be maintained until the processing job is ended. Thus, during the processing job, when the states of the charge management devices 2 and 3 are shifted, or the currently executed processing job is temporarily halted and is thereafter resumed, an unexpected change in the selected charge management device 2 or 3 can be prevented. Therefore, when there are a plurality of charge management devices 2 and 3 that can perform a charging process, an erroneous, unexpected user charge can be prevented, so that an appropriate charging process can be performed, and a very convenient system can be provided for users.

The embodiment has been explained; however, the present invention is not limited to this example. For example, not just two charge management devices 2 and 3, as in the embodiment, may be connected to the image processing apparatus 1 or the charge management device, attached connection device 4, but three or more. And as described above, the present invention can be variously modified without departing from the scope of the subject in the description of the embodiment.

The entire disclosure of Japanese Patent Application No. 2005-351477 filed on Dec. 6, 2005 including specification, claims, drawings and abstract is incorporated herein by reference in its entirety.

What is claimed is:

1. An image processing apparatus comprising:
a job processor that processes a job for image data; a job management unit that manages execution of the processing of the job;
a connector to which a plurality of charge management devices that charge for the processing of the job are connected;
a charge management selector that selects one of the plurality of charge management devices to charge for the processing of the job, the selection is based on operating states of the plurality of the charge management devices and is maintained until the processing of the job is performed; and
a storage unit that stores a result of the selection made by the charge management selector when the processing of the job is started.

2. The image processing apparatus according to claim 1, wherein, in the selecting the charge management device when the processing of the job is started, the charge management selector selects one of the plurality of the charge management devices based on when the plurality of charge management devices is shifted to an active state.

3. The image processing apparatus according to claim 1, wherein, even when the charge management device that is selected upon the start of the processing of the job is shifted from the active state to an inactive state while the job processor is processing the job, the charge management selector maintains the selection made upon the start of the processing of the job based on the contents of the storage unit.

4. The image processing apparatus according to claim 3, wherein the charge management selector maintains the selection made upon the start of the processing of the job only when the selected charge management device performs addition type charging.

5. The image processing apparatus according to claim 1, wherein, when the processing of the job performed by the job processor is interrupted and is thereafter resumed, the charge management selector selects the charge management device that is selected upon the start of the processing of the job based on the result of the selection stored in the storage unit.

6. The image processing apparatus according to claim 5, wherein the charge management selector selects the charge management device that is selected upon the start of the processing of the job only when both the charge management device that performs addition type charging and the charge management device that performs subtraction type charging are connected to the connector.

7. A charge management device connection device, which is located between an image processing apparatus for processing a job for image data and for controlling the processing of the job and a plurality of charge management devices for charging for the processing of the job, and which establishes a connection between the image processing apparatus and the charge management devices, the connection device comprising:
a charge management selector that selects one of the plurality of charge management devices to charge for the processing of the job performed by the image processing apparatus, the selection is based on operating states of the plurality of the charge management devices and is mainteined until the processing of the job is performed; and
a storage unit that stores a result of the selection made by the charge management selector when the processing of the job is started.

8. The charge management device connection device according to claim 7, wherein, in the selecting the charge management device when the processing of the job is started, the charge management selector selects one of the plurality of the charge management devices based on when the plurality of charge management devices is shifted to an active state.

9. The charge management device connection device according to claim 7, wherein, even when the charge management device that is selected upon the start of the processing of the job is shifted from the active state to an inactive state while the image processing apparatus is processing the job, the charge management selector maintains the selection made upon the start of the processing of the job based on the contents of the storage unit.

10. The charge management device connection device according to claim 9, wherein the charge management selector maintains the selection made upon the start of the processing of the job only when the selected charge management device performs addition type charging.

11. The charge management device connection device according to claim 7, wherein, when the processing of the job performed by the job processor is interrupted and is thereafter resumed, the charge management selector selects the charge management device that is selected upon the start of the processing of the job based on the result of the selection stored in the storage unit.

12. The charge management device connection device according to claim 11, wherein the charge management selector selects the charge management device that is selected upon the start of the processing of the job only when both the charge management device that performs addition type charging and the charge management device that performs subtraction type charging are present among the plurality of charge management devices that are connected.

13. A charge management program product for enabling a computer of an image processing system, which includes at least one of an image processing apparatus for processing a job for image data and for controlling the processing of the job, a charge management device connection device provided between the image processing apparatus and a plurality of charge management devices to establish a connection between the image processing apparatus and the charge management devices, and the plurality of charge management devices for charging for the processing of the job, to perform software instructions comprising:
selecting one of the charge management devices to charge for the processing of the job performed by the image processing apparatus, the selection is based on operating states of the plurality of the charge management devices and is maintained until the processing of the job is performed; and
storing in a storage unit a result of the selection made when the processing of the job is started.

14. A charge management method for use in an image processing system, which includes at least one of an image processing apparatus for processing a job for image data and for controlling the processing of the job, a charge management device connection device provided between the image processing apparatus and a plurality of charge management devices to establish a connection between the image processing apparatus and the charge management devices, and the plurality of charge management devices for charging for the processing of the job, the method comprising:
when the processing of the job is to be started, selecting one of the charge management devices to charge for the processing of the job performed by the image processing apparatus in accordance with all operating states of the charge management devices;
storing a result of the selection made for the charge management devices when the processing of the job is to be started; and
maintaining the selection based on the contents of the storage unit until the processing of the job is performed.
